(19) United States
(12) Patent Application Publication
(10) Pub. No.: US 2012/0255460 A1
(43) Pub. Date: Oct. 11, 2012

(54) OIL-BASED INK

(75) Inventors: Kazuya KAWAKAMI, Ibaraki-ken (JP); Teruaki OKAWA, Ibaraki-ken (JP)

(73) Assignee: RISO KAGAKU CORPORATION, Tokyo (JP)

(21) Appl. No.: 13/441,728

(22) Filed: Apr. 6, 2012

(30) Foreign Application Priority Data
Apr. 7, 2011 (JP) 085175/2011

(51) Int. Cl. C09D 11/10; C09D 11/06

(52) U.S. Cl. 106/31.49; 106/31.58; 524/111

(57) ABSTRACT

An oil-based ink contains at least a dye and an organic solvent, wherein the dye is contained by an amount ranging from 0.1 to 20 mass % relative to the total amount of the ink, and the organic solvent contains a five-membered heterocyclic compound having a C═O bond or a phosphoric acid ester by an amount ranging from 50 to 99 mass % relative to the total amount of the ink.

### BACKGROUND OF THE INVENTION

1. Field of the Invention

The present invention relates to an ink that is suitable for use with inkjet recording systems, and more particularly to an oil-based ink containing a dye as a colorant.

2. Description of the Related Art

Inkjet recording systems eject a highly fluid inkjet ink from very thin head nozzles as ink particles to record an image on a sheet of printing paper, which is positioned to face the nozzles. Because of low noise and ability of high-speed printing, and capability of inexpensively outputting variable data, the inkjet recording systems are rapidly becoming widely used in recent years. Inks for use with the inkjet recording systems are largely classified into three types: aqueous inks, solvent inks and oil-based inks.

The oil-based inks are less volatile than the solvent inks, and thus are superior in view of safety and facilitate maintenance. The oil-based inks do not cause cockling or curl, which is the case with the aqueous inks, and thus are frequently used as inks suitable for inkjet recording systems which perform high-speed printing (see, for example, U.S. Patent Application Publication No. 2007/0101901).

In view of the manner of drying, the printing inks are largely classified into three types: those of penetration drying type, which penetrate into a printing medium, such as paper, to be dried; those of volatilization drying type, which are volatilized after printing to be dried; and those of polymerization drying type, which dry and cure by themselves.

The oil-based inks use a solvent with low volatility and are not easily dried in the manner of volatilization drying, and therefore they mostly rely on the penetration drying. If the oil-based inks are used with print sheets with low porosity, such as glossy paper, there is a problem that the inks do not easily penetrate into the print sheets and are not fixed on the sheets.

### SUMMARY OF THE INVENTION

In view of the above-described circumstances, the present invention is directed to providing an oil-based ink which can be well fixed even on a print sheet with low porosity, such as glossy paper.

An aspect of the oil-based ink of the invention is an oil-based ink containing at least a dye and an organic solvent, wherein the dye is contained by an amount ranging from 0.1 to 20 mass % relative to the total amount of the ink, and the organic solvent contains a five-membered heterocyclic compound having a C═O bond or a phosphoric acid ester by an amount ranging from 50 to 99 mass % relative to the total amount of the ink.

The five-membered heterocyclic compound may preferably be at least one selected from a carbonate compound, a lactone compound, an imidazolidinone compound and a pyrrolidone compound.

The carbonate compound may preferably be at least one selected from ethylene carbonate, propylene carbonate, 1,2-butylene carbonate and derivatives thereof.

The lactone compound may preferably be at least one selected from γ-butyrolactone, a-acetyl-γ-butyrolactone, pentano-4-lactone and derivatives thereof.

The imidazolidinone compound may preferably be at least one selected from 2-imidazolidinone, 1,3-dimethyl-2-imidazolidinone, 1,3-diethyl-2-imidazolidinone, 1,3-dipropyl-2-imidazolidinone, 1,3-diisopropyl-2-imidazolidinone, 1,3-dibutyl-2-imidazolidinone and derivatives thereof.

The pyrrolidone compound may preferably be at least one selected from 2-pyrrolidone, N-methyl-pyrrolidone, 1-ethyl-2-pyrrolidone and derivatives thereof.

A content of a polymer component in the ink may preferably be 1 mass % or less relative to the total amount of the ink.

The polymer component herein refers to a polymer having a repeating structure of monomers and a molar weight of 500 or more.

The oil-based ink of the invention contains a dye by an amount ranging from 0.1 to 20 mass % relative to the total amount of the ink, and an organic solvent contained in the ink contains a five-membered heterocyclic compound having a C═O bond or a phosphoric acid ester by an amount ranging from 50 to 99 mass % relative to the total amount of the ink. Therefore, the oil-based ink of the invention can be well fixed even on a print sheet with low porosity, such as glossy paper. Although the exact mechanism thereof is not clear, it is believed that, since the five-membered heterocyclic compound and the phosphoric acid ester have a nature to well dissolve the dye and the five-membered heterocyclic compound and the phosphoric acid ester have low viscosity, one of these solvents contained in the ink by an amount ranging from 50 to 99 mass % relative to the total amount of the ink facilitates penetration of the dye even into a print sheet with low porosity, such as coated paper or glossy paper, under the capillary action, thereby promoting fixing of the ink on the print sheet.

In order to promote fixing of the ink on the glossy paper, it is effective to reduce an amount of transferred ink onto the paper. In the case of conventional oil-based inks, however, the reduction of the amount of transferred ink means decrease of image density. Further, even when the amount of transferred ink is reduced with sacrificing the image density, a sufficient level of fixing of the ink on the glossy paper has not yet been achieved. In contrast, the oil-based ink of the invention contains the five-membered heterocyclic compound or phosphoric acid ester, which well dissolves the dye, by an amount ranging from 50 to 99 mass % relative to the total amount of the ink, and therefore can more easily provide sufficient image density even under the condition where the amount of transferred ink is small, thereby allowing image formation with good image quality.

Thus, the oil-based ink of the invention is preferable as an ink for use with glossy paper.

### DESCRIPTION OF THE PREFERRED EMBODIMENTS

An oil-based ink of the invention (which may hereinafter simply be referred to as “ink”) contains at least a dye and an organic solvent, wherein the dye is contained by an amount ranging from 0.1 to 20 mass % relative to the total amount of the ink, and the organic solvent contains a five-membered heterocyclic compound having a C═O bond or a phosphoric acid ester by an amount ranging from 50 to 99 mass % relative to the total amount of the ink.

The five-membered heterocyclic compound may be liquid or solid. If the five-membered heterocyclic compound is solid, any solid five-membered heterocyclic compound that can dissolve in an organic solvent may be used. The organic solvent may be any of the organic solvents described later. Preferred examples of the five-membered heterocyclic compound may include a carbonate compound, a lactone compound, an imidazolidinone compound and a pyrrolidone compound.

Preferred examples of the carbonate compound may include ethylene carbonate, propylene carbonate, 1,2-butylene carbonate and derivatives thereof.

Preferred examples of the lactone compound may include γ-butyrolactone, a-acetyl-γ-butyrolactone, pentano-4-lactone and derivatives thereof.

Preferred examples of the imidazolidinone compound may include 2-imidazolidinone, 1,3-dimethyl-2-imidazolidinone, 1,3-diethyl-2-imidazolidinone, 1,3-dipropyl-2-imidazolidinone, 1,3-diisopropyl-2-imidazolidinone, 1,3-dibutyl-2-imidazolidinone and derivatives thereof.

Preferred examples of the pyrrolidone compound may include 2-pyrrolidone, N-methyl-pyrrolidone, 1-ethyl-2-pyrrolidone and derivatives thereof.

Examples of the derivatives above may include compounds with a hydrogen atom thereof substituted with a fluorine atom or an alkyl group with a carbon number of 1 to 4.

Preferred examples of the phosphoric acid ester may include a phosphoric acid monoester, a phosphoric acid diester and a phosphoric acid triester, and more specifically include trimethyl phosphate, triethyl phosphate, tributyl phosphate, triisopropyl phosphate, tripropyl phosphate, triamyl phosphate, triphenyl phosphate and derivatives thereof. Examples of the derivatives may include compounds with a hydrogen atom thereof substituted with a fluorine atom or an alkyl group with a carbon number of 1 to 4.

The five-membered heterocyclic compound or the phosphoric acid ester may be used singly or in combination of two or more species. In a case where two or more five-membered heterocyclic compounds or phosphoric acid esters are used in an appropriate combination, the total amount of the combined five-membered heterocyclic compounds or the phosphoric acid esters is within the range from 50 to 99 mass % relative to the total amount of the ink. More preferably, the total content of the five-membered heterocyclic compound(s) or the phosphoric acid triester(s) may be in the range from 60 to 97 mass % relative to the total amount of the ink. Since the five-membered heterocyclic compound and the phosphoric acid ester have low viscosity, they can be preferably used with inkjet inks.

The content of a polymer component in the ink is 1 mass % or less, or may preferably be 0.5 mass % or less, relative to the total amount of the ink. If a curable polymer is used, a content of the polymer component exceeding 1 mass % results in clogging of nozzles, and thus is not preferred. If a non-curable polymer is used, a content of the polymer component exceeding 1 mass % results in low level of fixing of the ink since the polymer component does not easily penetrate into the glossy paper or the coated paper, and thus is not preferred.

In a case where a polymeric dispersant is contained as the polymer component in the ink, examples of commercially available polymeric dispersants may include: SOLSPERSE series (SOLSPERSE 18000, 28000, 11200, 20000, 27000, 41000, 41090, 43000 and 44000) available from The Lubrizol Corporation; JONCRYL series (JONCRYL 57, 60, 62, 63, 71 and 501) available from BASF Japan Ltd.; polyvinyl pyrrolidone K-30 and K-90 available from Dai-Ichi Kogyo Seiyaku Co., Ltd., etc.

In a case where a resin is contained as the polymer component, examples of the resin may include: maleic resins, such as MALKYD NO. 31, NO. 32, NO. 33 and MALKYD NOS. 32 to 30WS available from Arakawa Chemical Industries, Ltd.; phenol resins, such as TAMANORI 751 and TAMANOL PA available from Arakawa Chemical Industries, Ltd.; styrene acrylic resins, such as JONCRYL 682 (trade name) available from BASF Japan Ltd.; ketone resins, such as HILAC 111 and 110H available from Hitachi Chemical Co., Ltd.; coumarone resins, such as ESCRON G90 and V120 available from Nippon Steel Chemical Co., Ltd.; polyvinyl formal resins, such as VINYLEC TYPE-E and TYPE-K available from Chisso Corporation; ε-caprolactam copolymers, such as NYLON 6 available from Ube Industries, Ltd.; polyvinyl butyral resins, such as ESLEC BL-1 and BL-2 available from Sekisui Chemical Co., Ltd.; polystyrenes, such as STYLAC-AS767 available from Asahi Kasei Corporation; polyacrylic acid esters, such as methyl polyacrylate; polymethacrylic acid esters, such as methyl polymethacrylate and propyl polymethacrylate; addition polymer resins, such as chlorinated polypropylene, polyvinyl acetate and maleic anhydride polymer; and condensation polymer resins, such as acrylonitrile-butadiene-styrene resin, chlorinated polypropylene, DFK resin, polyester, polyurethane and polyamide.

The organic solvent contained in the ink of the invention may totally consist of the five-membered heterocyclic compound or the phosphoric acid ester, or may include another organic solvent. Examples of the organic solvent other than the five-membered heterocyclic compound or the phosphoric acid ester may include water-soluble organic solvents, petroleum-based hydrocarbon solvents. Specific examples of the hydrocarbon solvents may include glycols, such as ethylene glycol, diethylene glycol, triethylene glycol, tetraethylene glycol, pentaethylene glycol, propylene glycol, dipropylene glycol and tripropylene glycol, glycerin, acetins, glycol derivatives, such as triethylene glycol monomethyl ether, triethylene glycol monobutyl ether, tetraethylene glycol monomethyl ether, tetraethylene glycol dimethyl ether and tetraethylene glycol diethyl ether, triethanolamine, β-thioglycol, sulfolane, AF-7, and AF-4. These water-soluble organic solvents may be used singly or in combination of two or more species.

In view of viscosity of the ink, the content of the organic solvent other than the five-membered heterocyclic compound or the phosphoric acid ester may preferably be 40 mass % or less relative to the total amount of the ink.

The dye for use with the ink of the invention may be any of conventionally known dyes. Among them, oil-soluble dyes, such as azo dyes, metal complex dyes, naphthol dyes, anthraquinone dyes, indigo dyes, carbonium dyes, quinonimine dyes, xanthene dyes, cyanine dyes, quinoline dyes, nitro dyes, nitroso dyes, benzoquinone dyes, naphthoquinone dyes, phthalocyanine dyes and metal phthalocyanine dyes are more preferred. These dyes may be used singly or in an appropriate combination, and the content of the dye(s) is in the range from 0.1 to 20 mass %, or may more preferably be in the range from 1 to 10 mass %, relative to the total amount of the ink. A content of the dye less than 0.1 mass % results in significantly low print density, and a content of the dye exceeding 20 mass % results in low scratch resistance.

Besides the above-described components, the ink of the invention may include conventional additives. Examples of the additives may include a surfactant, such as an anionic, cationic, amphoteric or nonionic surfactant, an antioxidant, such as dibutylhydroxytoluene, propyl gallate, tocopherol, butylhydroxyanisol or nordihydroguaiaretic acid, etc.

The ink of the invention can be prepared, for example, by putting all the components at once or in fractions in a known dispersing device, such as a bead mill, to disperse the components, and filtering them with a known filtering device, such as a membrane filter, as desired.

Examples of the ink of the invention are shown below.

### EXAMPLES

### Preparation of Ink

Ink samples of Examples and Comparative Examples were prepared by mixing materials according to each composition shown in Table 1 below (the numerical values shown in Table 1 are in parts by mass), stirring the mixture with a stirrer for one hour and filtering the mixture with a membrane filter having a pore size of 3 μm.

### Imaging

Sample images were printed under the following conditions.

Head: CB2 head (available from Toshiba Tec Corporation)
Resolution: 300 dpi×300 dpi
Image: monochromatic solid image
Amount of droplet per dot: 42 pL
Print sheet: glossy paper (those available from Mitsubishi Kagaku Media Co., Ltd., Seiko Epson Corporation, and DNP Photo Marketing Co., Ltd.)

### Evaluation of Fixing

A RISO PAPER IJ MAT (W) was placed on the top of each sample image 30 seconds after the printing, and the surface thereof was rolled with a plastic roller by moving the roller to reciprocate five times. Then, the level of contamination by the transferred ink on the IJ MAT (W) was visually observed and evaluated according to the following criteria.

A: no contamination was observed;
B: barely noticeable contamination was observed;
C: slightly noticeable contamination was observed; and
D: noticeable contamination was observed.

The formulation and the result of the evaluation of each ink sample are shown in Table 1.

| | | | Examples | | | | | | | |
|---|---|---|---|---|---|---|---|---|---|---|
| | | | 1 | 2 | 3 | 4 | 5 | 6 | 7 | 8 |
| Pigment | Carbon black (MA11 available from Mitsubishi | | | | | | | | | |
| | Chemical Corporation) | | | | | | | | | |
| Dye | RED (Water RED 27 available from Orient Chemical | | | | | 6.00 | | 6.00 | | |
| | Industries Co., Ltd.) | | | | | | | | | |
| | BLUE (OIL BLUE 613 available from Orient Chemical | | | | | | 6.00 | | | |
| | Industries Co., Ltd.) | | | | | | | | | |
| | BLACK (ValiFast Black 3810 available from Orient | | 6.00 | 6.00 | 6.00 | | | | 6.00 | 6.00 |
| | Chemical Industries Co., Ltd.) | | | | | | | | | |
| Dispersant | S18000 (polyamide-based dispersant having | | | | | | | | | |
| | polyester chain) | | | | | | | | | |
| Non- | Five-membered | Propylene carbonate | 90.00 | | | | 90.00 | 90.00 | 70.00 | 50.00 |
| Aqueous | heterocyclic | Ethylene carbonate | | 90.00 | | | | | | |
| Solvent | compound | 1,2-butylene carbonate | | | 90.00 | | | | | |
| | Phosphoric acid | Triethyl phosphate | | | | 90.00 | | | | |
| | ester | | | | | | | | | |
| | Boric acid ester | Triisopropyl borate | | | | | | | | |
| | Silicic acid ester | Ethyl silicate | | | | | | | | |
| | Higher | Isomyristyl alcohol | | | | | | | | |
| | alcohol-based | | | | | | | | | |
| | Ester-based | Isooctyl palmitate | | | | | | | | |
| | Petroleum-based | AF7 | 4.00 | 4.00 | 4.00 | 4.00 | 4.00 | 4.00 | 24.00 | 44.00 |
| | hydrocarbon | | | | | | | | | |

| Total (parts by mass) | | 100.00 | 100.00 | 100.00 | 100.00 | 100.00 | 100.00 | 100.00 | 100.00 |
|---|---|---|---|---|---|---|---|---|---|
| Evaluation of Ink Fixing | Glossy Photo Paper available from | A | A | A | A | A | A | A | A |
| Level | Mitsubishi Kagaku Media | | | | | | | | |
| | Photo Paper Entry <Glossy> available | A | A | A | A | A | A | A | A |
| | from Seiko Epson | | | | | | | | |
| | Photo Quality <Glossy Thin> available | A | A | A | A | A | A | A | A |
| | from DNP Photo Marketing | | | | | | | | |

| | | | Examples | | | | Comparative Examples | | |
|---|---|---|---|---|---|---|---|---|---|
| | | | 9 | 10 | 11 | 12 | 1 | 2 | 3 |
| Pigment | Carbon black (MA11 available from Mitsubishi | | | | | | 7.20 | | |
| | Chemical Corporation) | | | | | | | | |
| Dye | RED (Water RED 27 available from Orient Chemical | | | | | | | | |
| | Industries Co., Ltd.) | | | | | | | | |
| | BLUE (OIL BLUE 613 available from Orient Chemical | | | | | | | | |
| | Industries Co., Ltd.) | | | | | | | | |
| | BLACK (ValiFast Black 3810 available from Orient | | 6.00 | 6.00 | 6.00 | 20.00 | | 7.20 | 25.00 |
| | Chemical Industries Co., Ltd.) | | | | | | | | |
| Dispersant | S18000 (polyamide-based dispersant having | | | 1.00 | 0.50 | | 2.00 | 2.00 | |
| | polyester chain) | | | | | | | | |
| Non- | Five-membered | Propylene carbonate | 94.00 | 90.00 | 90.00 | 70.00 | | | 75.00 |
| Aqueous | heterocyclic | Ethylene carbonate | | | | | | | |
| Solvent | compound | 1,2-butylene carbonate | | | | | | | |
| | Phosphoric acid | Triethyl phosphate | | | | | | | |
| | ester | | | | | | | | |
| | Boric acid ester | Triisopropyl borate | | | | | | | |
| | Silicic acid ester | Ethyl silicate | | | | | | | |
| | Higher | Isomyristyl alcohol | | | | | 7.00 | 7.00 | |
| | alcohol-based | | | | | | | | |
| | Ester-based | Isooctyl palmitate | | | | | 43.80 | 43.80 | |
| | Petroleum-based | AF7 | | 3.00 | 3.50 | 10.00 | 40.00 | 40.00 | |
| | hydrocarbon | | | | | | | | |

| Total (parts by mass) | | 100.00 | 100.00 | 100.00 | 100.00 | 100.00 | 100.00 | 100.00 |
|---|---|---|---|---|---|---|---|---|
| Evaluation of Ink Fixing | Glossy Photo Paper available from | A | B | A | B | D | D | C |
| Level | Mitsubishi Kagaku Media | | | | | | | |
| | Photo Paper Entry <Glossy> available | A | B | A | B | D | D | C |
| | from Seiko Epson | | | | | | | |
| | Photo Quality <Glossy Thin> available | A | B | A | B | D | D | C |
| | from DNP Photo Marketing | | | | | | | |

As can be seen from Table 1, Examples 1 to 12, which were the ink of the invention, were well fixed on any of the three types of glossy paper. Example 10 was an ink containing a polymer component by an amount of 1 mass % relative to the total amount of the ink, and the lower fixing level thereof than the other Examples is believed to be caused by the polymer component that did not easily penetrate into the glossy paper. Example 12, which had a very high dye content of 20 mass %, also had slightly lower fixing level than the other Examples, because a large amount of the colorant tended to remain on the surface of the paper.

Comparative Example 1 was a pigment ink and Comparative Example 2 was a dye ink. In these cases, the pigment or the dye was only dispersed in the organic solvent, which included the higher alcohol-based solvent, the ester-based solvent and the petroleum-based solvent, by the dispersant, and the fixing levels of the ink samples of these Comparative Examples were significantly poor, because these organic solvents did not penetrate into the glossy paper with low porosity. Further, Comparative Example 3, which had a very high dye content of 25 mass %, was also poorly fixed, and the reason is believed that the dye content exceeded the limit of the amount of dye that can penetrate into the paper under the capillary action.

As described above, the organic solvent in the oil-based ink of the invention contains the five-membered heterocyclic compound having a C═O bond or the phosphoric acid ester, which has a nature to well dissolve the dye, by an amount ranging from 50 to 99 mass % relative to the total amount of the ink. Therefore, the ink of the invention allows producing good color on the glossy paper even under the condition where the amount of transferred ink is small, and therefore can more easily provide sufficient image density, thereby allowing image formation with good image quality. Further, even under the condition where the amount of transferred ink is large, the dye contained in the ink of the invention easily penetrates into the paper under the capillary action, thereby promoting fixing of the ink.

What is claimed is:

1. An oil-based ink comprising at least a dye and an organic solvent, wherein the dye is included by an amount ranging from 0.1 to 20 mass % relative to a total amount of the ink, and the organic solvent includes a five-membered heterocyclic compound having a C═O bond or a phosphoric acid ester by an amount ranging from 50 to 99 mass % relative to the total amount of the ink.

2. The oil-based ink as claimed in claim 1, wherein the five-membered heterocyclic compound is at least one selected from a carbonate compound, a lactone compound, an imidazolidinone compound and a pyrrolidone compound.

3. The oil-based ink as claimed in claim 2, wherein the carbonate compound is at least one selected from ethylene carbonate, propylene carbonate, 1,2-butylene carbonate and derivatives thereof.

4. The oil-based ink as claimed in claim 2, wherein the lactone compound is at least one selected from γ-butyrolactone, a-acetyl-γ-butyrolactone, pentano-4-lactone and derivatives thereof.

5. The oil-based ink as claimed in claim 2, wherein the imidazolidinone compound is at least one selected from 2-imidazolidinone, 1,3-dimethyl-2-imidazolidinone, 1,3-diethyl-2-imidazolidinone, 1,3-dipropyl-2-imidazolidinone, 1,3-diisopropyl-2-imidazolidinone, 1,3-dibutyl-2-imidazolidinone and derivatives thereof.

6. The oil-based ink as claimed in claim 2, wherein the pyrrolidone compound is at least one selected from 2-pyrrolidone, N-methyl-pyrrolidone, 1-ethyl-2-pyrrolidone and derivatives thereof.

7. The oil-based ink as claimed in claim 3, wherein a content of a polymer component in the ink is 1 mass % or less relative to the total amount of the ink.

8. The oil-based ink as claimed in claim 4, wherein a content of a polymer component in the ink is 1 mass % or less relative to the total amount of the ink.

9. The oil-based ink as claimed in claim 5, wherein a content of a polymer component in the ink is 1 mass % or less relative to the total amount of the ink.

10. The oil-based ink as claimed in claim 6, wherein a content of a polymer component in the ink is 1 mass % or less relative to the total amount of the ink.

11. The oil-based ink as claimed in claim 1 for use with glossy paper.

12. The oil-based ink as claimed in claim 2 for use with glossy paper.

13. The oil-based ink as claimed in claim 3 for use with glossy paper.

14. The oil-based ink as claimed in claim 4 for use with glossy paper.

15. The oil-based ink as claimed in claim 5 for use with glossy paper.

16. The oil-based ink as claimed in claim 6 for use with glossy paper.

17. The oil-based ink as claimed in claim 7 for use with glossy paper.

18. The oil-based ink as claimed in claim 8 for use with glossy paper.

19. The oil-based ink as claimed in claim 9 for use with glossy paper.

20. The oil-based ink as claimed in claim 10 for use with glossy paper.
